(19) United States
(12) Patent Application Publication
(10) Pub. No.: US 2026/0208651 A1
(43) Pub. Date: Jul. 23, 2026

(54) VEHICLE DELIVERY BOX SYSTEM AND METHOD

(71) Applicants: Albert Posthumus, Stephenville, TX (US); Rein Posthumus, Dalhart, TX (US)

(72) Inventors: Albert Posthumus, Stephenville, TX (US); Rein Posthumus, Dalhart, TX (US)

(21) Appl. No.: 19/456,603

(22) Filed: Jan. 22, 2026

Related U.S. Application Data
(60) Provisional application No. 63/756,684, filed on Feb. 10, 2025.
(60) Provisional application No. 63/748,564, filed on Jan. 23, 2025.

(51) Int. Cl. B60P 1/00; B65D 88/54

(52) U.S. Cl. CPC B60P 1/003; B65D 88/54

(57) ABSTRACT

A delivery box system includes a delivery box having a bottom wall and a sidewall defining a storage area for storing a commodity material. The delivery box system further includes a first metering aperture disposed on the sidewall of the delivery box. The delivery box system further includes an expulsion mechanism operable to dispense a stored commodity material through the first metering aperture. The expulsion mechanism includes a distribution member rotatable about an axis, the distribution member having an upper surface and a lower surface. A portion of the distribution member extends at least partially through the first metering aperture such that, in response to rotation of the distribution member, the stored commodity material is dispensed through the first metering aperture.

### CROSS-REFERENCE TO RELATED APPLICATIONS

This application claims priority to and the benefit of Provisional Patent Application No. 63/748,564, filed January 23, 2025, and Provisional Patent Application No. 63/756,684, filed February 10, 2025, the entire disclosures of which are incorporated herein by reference in their entireties for all purposes.

### TECHNICAL FIELD

The present disclosure relates to delivery boxes, and in particular, to a system and method for efficiently transporting and unloading commodity material, such as animal feed, from a delivery box.

### BACKGROUND

Commodity transportation vehicles having delivery boxes are frequently implemented to release contained commodities in a controlled way, such as to release feed material for animals. However, challenges are associated with such delivery boxes in connection with different commodity types. For instance, various commodities are prone to jamming the mechanical workings of the delivery box or occluding the passage out from the delivery box, impeding effective and controlled delivery of the commodities being released. Rotating mechanical parts are particularly susceptible to jamming by fibrous commodities, such as hay or alfalfa. Thus, there are operational challenges in the field for delivering precise quantities of commodities without jamming the delivery box mechanical systems.

Moreover, frequent challenges arise with adapting delivery boxes for use with different commodities having different material properties. For example, fibrous commodities behave differently in bulk than smaller particulate commodities such as seeds or grains. Thus, there is a further jamming and occlusion challenge arising from processing varied commodities by the commodity transportation vehicle having the delivery box as well as operational efficiency challenges associated with changing the delivery box or aspects thereof in connection with changing the type of commodity being handled.

### SUMMARY OF THE INVENTION

In some embodiments, the techniques described herein relate to a delivery box system. The delivery box system includes a delivery box having a bottom wall and a sidewall defining a storage area for storing a commodity material. The delivery box system further includes a first metering aperture disposed on the sidewall of the delivery box. The delivery box system further includes an expulsion mechanism operable to dispense a stored commodity material through the first metering aperture. The expulsion mechanism includes a distribution member rotatable about an axis, the distribution member having an upper surface and a lower surface. A portion of the distribution member extends at least partially through the first metering aperture such that, in response to rotation of the distribution member, the stored commodity material is dispensed through the first metering aperture.

In some embodiments, the techniques described herein relate to a delivery box system. The delivery box system includes a delivery box having a bottom wall and a sidewall defining a storage area for storing a commodity material, a first metering aperture disposed on the sidewall of the delivery box. The delivery box system further includes a second metering aperture disposed on the sidewall of the delivery box. The delivery box system further includes a first angled plate positioned adjacent the first metering aperture and extending away from the delivery box at a first angle. The delivery box system further includes a second angled plate positioned adjacent a bottom portion of the second metering aperture and extending away from the delivery box at a second angle. The delivery box system further includes a first expulsion mechanism including a first distribution member, a first central support joined to the first distribution member, the first expulsion mechanism positioned adjacent the first metering aperture and a portion of the first distribution member extending through the first metering aperture above the first angled plate. The delivery box system further includes a second expulsion mechanism including a second distribution member and a second central support joined to the second distribution member, the second expulsion mechanism positioned adjacent the second metering aperture and a portion of the second distribution member extending through the second metering aperture above the second angled plate. The first expulsion mechanism and the second expulsion mechanism are each configured to rotate about a vertical axis or an axis that is perpendicular to the bottom wall of the delivery box, such that in response to rotation of the first distribution member and the second distribution member, the commodity material is dispensed through the first metering aperture and the second metering aperture.

In some embodiments, the techniques described herein relate to a method of operating a delivery box system. The method includes opening a door of a metering aperture of a delivery box to a desired position. The method further includes rotating an expulsion mechanism thereby ejecting at least a portion of a commodity stored within the delivery box through the metering aperture. The method further includes closing the door associated with the metering aperture. The expulsion mechanism includes a distribution member configured to rotate around an axis perpendicular to a floor of the delivery box to dispense the commodity. A portion of the distribution member extends through the metering aperture during operation of the delivery box system.

### BRIEF DESCRIPTION OF THE DRAWINGS

FIG. 1 is a perspective view of a vehicle having a delivery box system according to an embodiment of the present disclosure.

FIG. 2 is a perspective view of a delivery box system according to an embodiment of the present disclosure.

FIG. 3 is a side view of a delivery box system according to an embodiment of the present disclosure.

FIG. 4 is a perspective view of the upper side of a distribution member of a delivery box system according to an embodiment of the present disclosure.

FIG. 5 is a perspective view of the lower side of a of distribution member of a delivery box system according to an embodiment of the present disclosure.

FIG. 6 is a perspective view of the upper side of a distribution member of a delivery box system according to an embodiment of the present disclosure.

FIG. 7 is a perspective view of the lower side of a of distribution member of a delivery box system according to an embodiment of the present disclosure.

FIG. 8 is a schematic of a method of operating a delivery box system, according to an embodiment of the present disclosure.

### DETAILED DESCRIPTION

As will be explained in more detail below, the delivery box system facilitates distribution of commodity materials stored within a delivery box. For example, animal feed materials such as hay, alfalfa, corn, grain, and/or a mixture of these materials can be distributed by the delivery box system. The delivery box system disperses feed by rotation of one or more distribution members, which are configured to rotate about an axis that is vertical or about perpendicular to a bottom surface of the delivery box. The rotation of the distribution members causes a portion of commodity material stored within the delivery box to pass through one or more metering apertures. One skilled in the art will recognize that the present disclosure provides a delivery box system that is able to operate without becoming jammed by the commodity material.

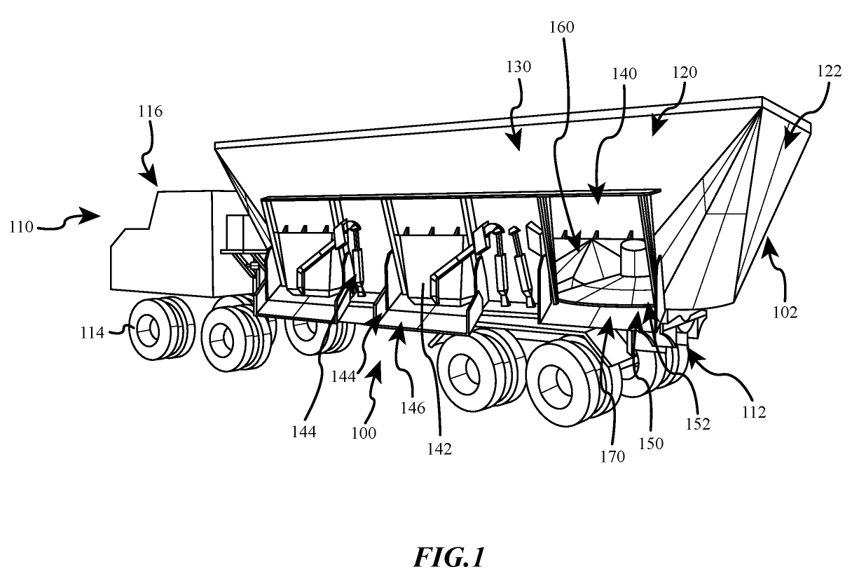

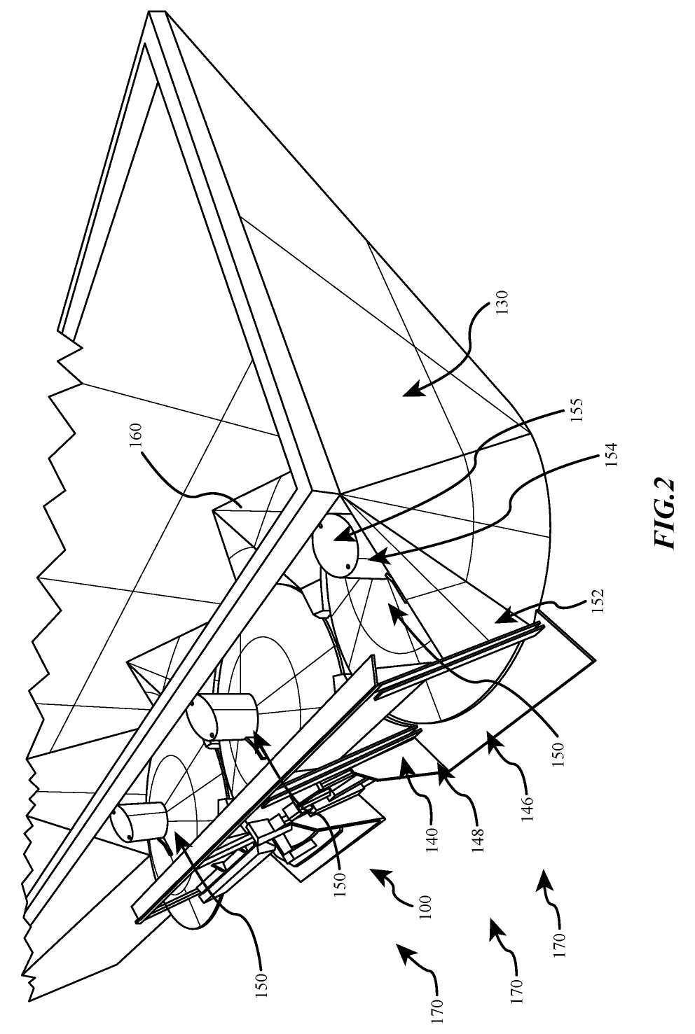

Referring to FIGS. 1 and 2, a vehicle 110 supporting a delivery box system 100 is shown. The delivery box system includes a delivery box 102 having a storage area 130. For the purpose of the present disclosure, in FIG. 1, the vehicle 110 is illustrated as an off-highway truck. However, the precise conformation of the vehicle can take any suitable form. The vehicle 110 can include a chassis 112 to support various components of the vehicle 110. The vehicle 110 can include a body of the delivery box 102 supported on the chassis 112. The chassis 112 can further support an operator cab 116 defined as an enclosure which an operator can occupy during operation of the delivery box system 100. An operator occupying the operator cab 116 can control various functions of the delivery box system 100 by issuing various operator commands by means of controls such as a joystick, a lever, a button, a wheel, a dial, a slider, a touch-based user interface, voice-commands, or the like. The vehicle 110 can include wheels 114 for ease of transporting the delivery box system 100. In some embodiments, the delivery box 102 is mountable on a wheeled trailer.

The delivery box 102 is formed of one or more sidewalls 120. In some embodiments, the delivery box also includes a front wall (not shown) and/or a rear wall 122. In embodiments including a front and/or a rear wall 122, the front and/or rear walls are coupled to or engage with the one or more sidewalls 120 to define the storage area 130. In other embodiments, the shape of the one or more sidewalls 120 is such that a front and/or rear wall 122 is not required to define the storage area 130 (e.g., as non-limiting examples, the delivery box can be cylindrical, spherical, semi-cylindrical, semi-spherical, elliptical, semi-elliptical, or stadium-shaped, thus not requiring a front/back wall). As depicted in the figures, the delivery box 102 can have a rectangular shape, such as the tapered rectangle shape shown in FIG. 1.

The storage area 130 of the delivery box 102 is configured to hold a commodity material prior to and during delivery. The sidewalls 120 forming the storage area 130 can be sloped to assist with directing the flow or position of commodity material within the storage area 130. Alternatively or additionally, the sloped features 160 can further assist with directing the flow or position of commodity material within the storage area 130. In some embodiments, the sloped features 160 have a cone or conical frustrum shape. The storage area 130 can have an open top, a partially open top, or a closed top. In embodiments in which the top of the storage area 130 is closed or partially open, the enclosed portion can be provided by a fixed wall, a removable lid, or a combination thereof.

The delivery box 102 includes one or more metering apertures 140 disposed on the sidewalls 120 of the delivery box. The metering apertures 140 are opening through a wall of the delivery box, allowing communication between the storage area 130 of the delivery box and the exterior of the delivery box. Thus, commodity stored within the storage area 130 can be expulsed or otherwise moved out of the delivery box 102. The metering aperture 140 includes an aperture plate 146 extending from a bottom portion of the metering aperture away from the delivery box. Additional guide plates 148 can be provided at or near the sides of the metering aperture 140, so as to provide a chute structure for directing the commodity material as it is expulsed from the storage area 130. The aperture plate 146 and additional guide plates 148 serve to direct material away from the delivery box 102, preventing commodity material from being run over by the vehicle 110 during operation of the delivery box.

The metering apertures 140 are adjustable such that the flow of commodity from the delivery box can be controlled. In some embodiments, the size of the opening provided by a metering aperture 140 is adjustable, permitting a user to control the volumetric or mass flow rate of commodity through the aperture. For example, in some embodiments, a door 142 disposed adjacent to the metering aperture is able to reduce or increase the size of the opening provided by a metering aperture 140. In some embodiments, the door 142 is slidably moveable incrementally between a lowered closed position and a raised open position, thereby adjusting the size of the opening provided by a metering aperture 140. In other embodiments, the door 142 is hingedly movable incrementally between an open position and a closed position, thereby adjusting the size of the opening provided by a metering aperture 140. In some embodiments, the position of the door 142 is manually adjustable, able to be moved by an operator and locked into a desired position. In some embodiments, the door 142 includes a curved recess configured to accommodate a portion of the distribution member 152. Indicator markings can be provided on portions of the door 142, the metering aperture 140, or other portions of the delivery box 102 to indicate the size of the opening provided or to indicate an expected flow rate of commodity through the metering aperture for a given aperture size or door position. Flow rates can be provided on a volumetric or mass basis. In other embodiments, the door 142 position can be controllable by a door positioning system 144. As illustrated in FIGS. 1 and 2, the door positioning system 144 can include one or more hydraulic members operable to move the door 142 to a desired position.

With continued reference to FIGS. 1 and 2, the delivery box 102 includes one or more expulsion mechanisms (e.g., the auger assemblies 150) that are operable to dispense a commodity material stored in the storage area 130 through a metering aperture 140. It should be noted that vehicle FIGS. 1 and 2 show three expulsion mechanisms, any number of expulsion mechanisms can be used in the system. In some embodiments, the delivery box system 100 includes a single expulsion mechanism. In other embodiments, the delivery box system 100 includes two expulsion mechanisms. In other embodiments, the delivery box system 100 includes five expulsion mechanisms.

The expulsion mechanism 170 includes a distribution member 152 (e.g., a distribution plate) that is rotatable around an axis, such that the distribution member 152 is able to rotate within the delivery box. In some embodiments, the axis of rotation for the distribution member 152 is vertical. In other embodiments, the axis of rotation for the distribution member 152 is approximately vertical. In other embodiments, the axis of rotation for the distribution member 152 is perpendicular to the floor or lower surface of the delivery box 102, allowing the distribution member to rotate in a plane that is approximately parallel to the floor of the delivery box or that is approximately horizontal when the delivery box is on a level surface. In embodiments including multiple expulsion mechanisms, the distribution members 152 of the expulsion mechanisms can each rotate in the same direction, or some of the distribution members can rotate in a first direction while the others rotate in second direction. As a non-limiting example, in an embodiment having three expulsion mechanisms arranged in linear relation (as illustrated in FIGS. 1 and 2), a first distribution member (an end plate) is configured to rotate in a first direction while the third distribution member (the opposite end plate) is configured to rotate in a second direction. The second distribution member (middle plate) is configured to rotate in either direction as desired by the operator of the delivery box.

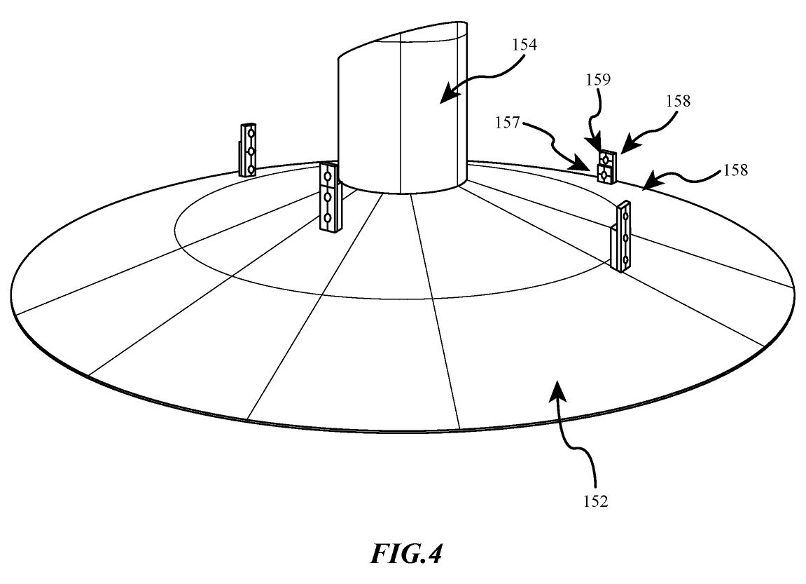

With reference now to FIGS. 2 and 4-5, the expulsion mechanism 170 includes an auger assembly 150 having a central housing 154 that engages with or is otherwise coupled to the distribution member 152. The central housing 154 provides mechanical support to the distribution member 152 during operation. The central housing 154 can be disposed adjacent to an inner diameter of the distribution member 152. The central housing can also house mechanical portions of the expulsion mechanism 170. For example, the central housing 154 of the auger assembly 150 can house gears, rotors, stators, motors, bearings, flanges, and/or pneumatics needed to facilitate the rotational motion of the distribution member 152 during operation of the delivery box 102. The central housing includes a cover portion 155. In some embodiments the cover portion 155 is sloped. In other embodiments, the cover portion 155 is flat. In still other embodiments, the cover portion 155 is conical to reduce the incidence of commodity material becoming stuck on the cover portion, wherein the cone tip can be rounded or pointed.

The auger assembly 150 includes one or more agitation members 158 extending from the upper surface of the distribution member 152. The agitation members serve to engage the commodity material in the storage area 130 during operation of the expulsion mechanism 170. For example, the agitation members 158 can stir small or pelletized commodities such as food pellets, seeds or grain, or can pull on and break up fibrous commodity material such as hay and alfalfa. The agitation members 158 are adjustable in height and can extend from between one (1) inch to 24 inches from the surface of the distribution member 152. In some embodiments, the agitation members 158 are adjustable from one (1) inch to six (6) inches. In other embodiments, the agitation members 158 are adjustable from three (3) inches to twelve (12) inches. In other embodiments, the agitation members 158 are adjustable from six (6) inches to twelve (18) inches.

The agitation members 158 include a first fixed portion 157 that is coupled to the upper surface of the distribution member 152 and an adjustable portion 159 that is able to be positioned relative to the fixed portion so as to adjust the overall height of the agitation members. The fixed portion 157 and adjustable portion can interface in any way known in the art. For example, in some embodiments, the fixed portion 157 and the adjustable portion 159 include holes through which bolts can be fixed, thereby fixing the height of the agitation member 158. In other embodiments, the agitation member includes a screw mechanism that is able to move the height of the adjustable portion 159 relative to the fixed portion 157. In some embodiments, the adjustable portion 159 is slidably coupled with the fixed portion 157.

In some embodiments, the upper surface of the distribution member 152 is flat. In other embodiments, the upper surface of the distribution member 152 is sloped at an angle. In some embodiments, the upper surface of the distribution member 152 is a conical frustrum. In some embodiments, the upper surface of the distribution member 152 is curved, presenting a sloped surface where the angle of the surface is not a constant function of the radial position (i.e., non-linear slope). The sloped surface urges commodity material on the distribution member 152 towards the outer edge of the distribution member where it can more readily be expulsed through the metering aperture 140 of the delivery box 102.

In embodiments where the distribution member is angled, the angle presented by the upper surface of the distribution member ranges from 5-45 degrees. In some embodiments, the angle is from 20-30 degrees. In other embodiments, the angle is 30 degrees. In other embodiments, the angle is from about 15 to about 65 degrees. In yet other embodiments, the angle is 5, 10, 15, 20, 25, 30, 35, 40, or 45 degrees. In embodiments where the upper surface has a non-linear slope, the overall angle provided by the upper surface (measured from the highest point of the sloped surface to the lowest) ranges from 5-45 degrees.

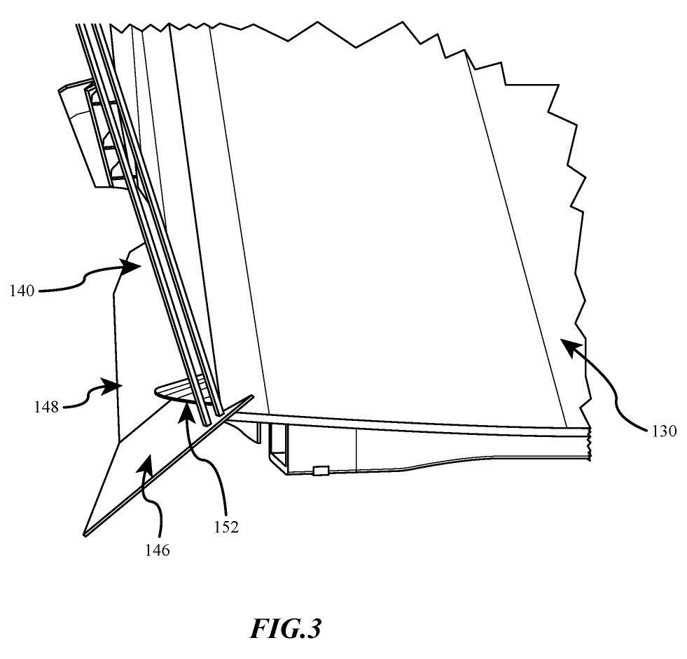

Turning now to FIG. 3, the distribution member 152 sits above the floor or lower surface of the delivery box 102 such that a space exists between the distribution member and the floor. During operation of the delivery box 102, commodity material stored in the storage area 130 of the delivery box can fall under the distribution member into the space between the plate and the floor or lower surface of the delivery box. Due to the rotational movement of the distribution member 152 and associated mechanisms, such material could become jammed beneath the plate, hampering or preventing operation of the expulsion mechanism. To address this issue, a portion of the distribution member 152 extends through the metering aperture 140 to provide an outlet to commodity material underneath the distribution member. To accommodate for the distribution member extending through the metering aperture, the bottom of the door 142 can have a curvature such that the bottom of the door is able to engage with the distribution member, thereby providing secure closure of the delivery box 102.

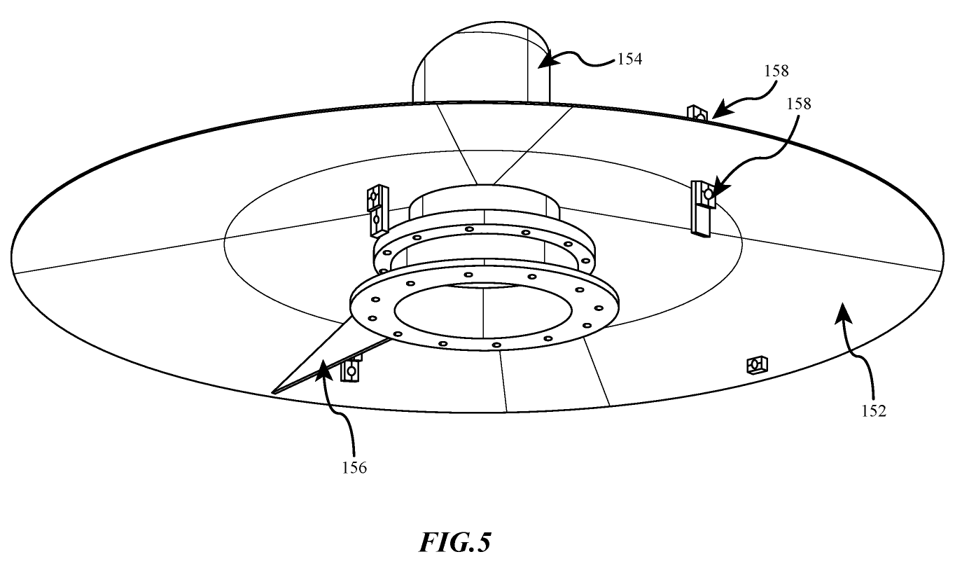

Additionally, as can be seen in FIG. 5, the distribution member 152 includes a rib member 156 member extending downward from the bottom surface of the distribution member. This rib member 156 serves to sweep commodity material accumulated below the distribution member 152 as the plate rotates. The swept material is urged toward the outer edge of the distribution member 152 by the shape and position of the rib member 156. Thus, as the distribution member 152 rotates, the commodity material underneath the distribution member is pushed toward the outer edge where it is expelled through the metering aperture 140 by the rib member 156. The aperture plate 146 of the metering aperture 140 provides a sloped surface for the commodity material to fall onto, thereby distributing the commodity material away from the delivery box 102. In some embodiments, the rib member 156 extends from a minor diameter (e.g., a smaller diameter) of the distribution member 152 toward a major diameter (e.g., a larger diameter) of the distribution member 152.

With continued reference to FIG. 5, the agitation members 158 present on the upper surface of the distribution member can extend through the distribution member such that at least a portion of the agitation members can also extend downward from the lower surface of the distribution member. In this way, a portion of the adjustable portion 159 of the agitation member 158 can be stored beneath the distribution member.

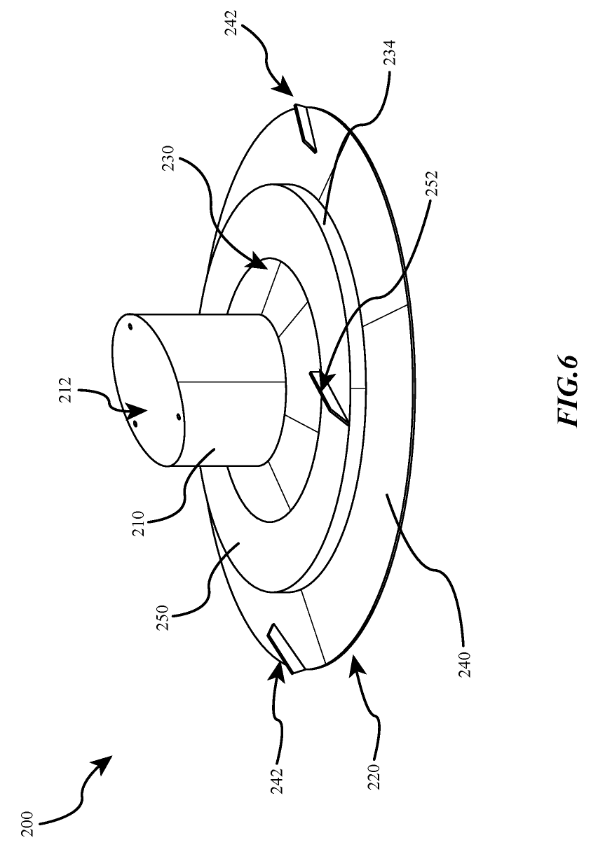

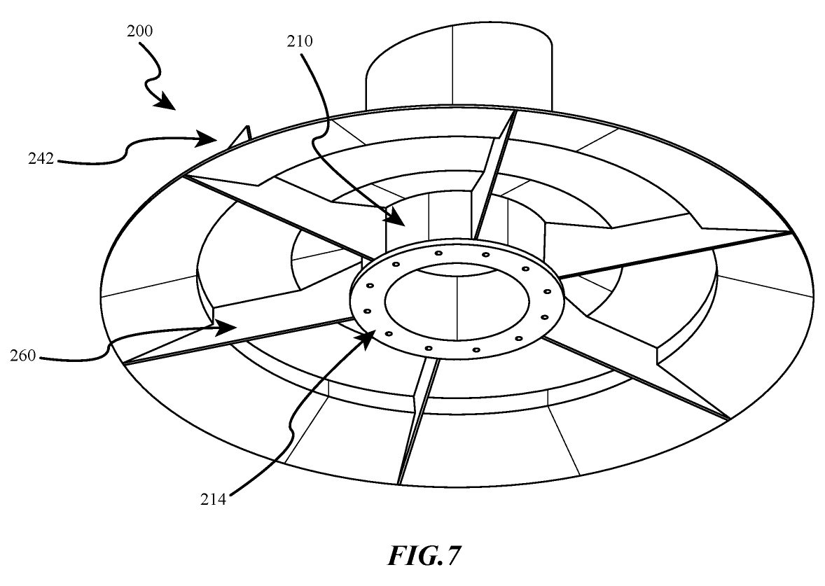

Turning now to FIGS. 6 and 7 and with continued reference to FIG. 2, another embodiment of an auger assembly 200 for use with the expulsion mechanism is shown. The auger assembly 200 includes a central housing 210 having a cap 212 with a distribution member 220 extending from the central housing. The cap 212 of the central housing can be flat but is preferably sloped to present an angled surface to commodity in the delivery box 102, so as to assist in moving the commodity material toward the lower portions of the auger assembly. The distribution member includes one or more sections 230, 240, and/or 250. In the embodiment shown in FIGS. 6 and 7, the distribution member includes three concentric sections: a first sloped section 230, a first flat section 250, and a second sloped section 240. Other configurations of concentric sections are also possible and should not be considered to be limited to the configuration illustrated in FIGS. 6 and 7. Any configuration having two or more concentric sections have differing surface angles can be used. For example, the auger assembly 200 can include two sections, three sections, four sections, or five sections. The sections can be flat (i.e., level or horizontal with respect to the floor of the delivery box 102) or can present an angled surface. In some embodiments, the angled surfaces of the sections are angled from 5-30 degrees. In some embodiments, the angled surfaces of the sections are angled from 5-45 degrees.

One or more engagement blades 242 and/or 252 are members that extend from one or more of the surfaces. FIG. 6 illustrates engagement blades 242 and/or 252 extending from a first flat section 250 and a surface of the second sloped section 240. However, more or fewer engagement blades than shown can be used, and the engagement blades can be positioned on any of the surfaces. The engagement blades 242 and/or 252 are configured to engage with commodity material held within the delivery box 102 as the auger assembly 200 is rotated about its axis. For example, in the embodiment illustrated in FIG. 6, the engagement blade 252 extending from the first flat section 250 pushes commodity material onto the second sloped section 240. The engagement blades 242 of the second sloped section 240 push the commodity material outward, causing the material to be ejected from the delivery box 102. The engagement blades can extend from the surface normal to the surface or they can be angled with respect to the underlying surface. The engagement blades can extend radially away from the central housing 210 of the auger assembly 200, or can extend at an angle therefrom. For example, an engagement blade 252 is shown in FIG. 6 which is radially angled with respect to the central housing 210 but extends about vertically from the first flat section 250. Another engagement blade 242 is also radially angled and is angled with respect to the first flat section 250. The engagement blades 242 and/or 252 can be adjustable to change the size, height, length, radial angle, and surface angle so as to adjust how the blades engage with a commodity material stored in the delivery box 102.

As shown in FIG. 6, the sections can be offset from one another in elevation, resulting in a lip 234 between the sections. For example, as illustrated in FIG. 6, an outer perimeter of the first flat section 250 is elevated with respect to an inner perimeter of the second sloped section 240, providing a lip 234. The difference in elevation can result in commodity material on the distribution member 152 “bridging” or extending across one or more of the sections such that a cavity exists between a portion of the commodity and the lower section. For example, a bulk commodity material can substantially rest on the first flat section 250 and “bridge” over the second sloped section 240 such that the engagement blades 242 can engage the commodity, thereby separating portions of the commodity from the bulk, while most of the second sloped section 240 is not in direct contact with the bulk commodity. This bridging effect can reduce the amount of torque required to operate the auger assembly 200, as the sections further from the central housing 210 (and therefore having a greater lever moment) are not in direct contact with the bulk commodity.

Specifically referring to FIG. 7, the underside of the auger assembly 200 can include one or more ribs 260 or fins extending outwardly from the central housing 210. These ribs assist in moving commodity that has fallen under the auger assembly 200 to be pushed out of the delivery box 102 through the metering apertures 140. Any number of ribs can be used, including one, two, three, four, five, six, eight, or ten ribs. A flange 214 is attached at the bottom of the central housing 210 that is configured to be coupled to a power source to provide the rotational force for operating the auger assembly 200. For example, the flange can be bolted to a gear or flywheel or another flange that is rotated by a motor or other power source, thereby causing the auger assembly 200 rotate.

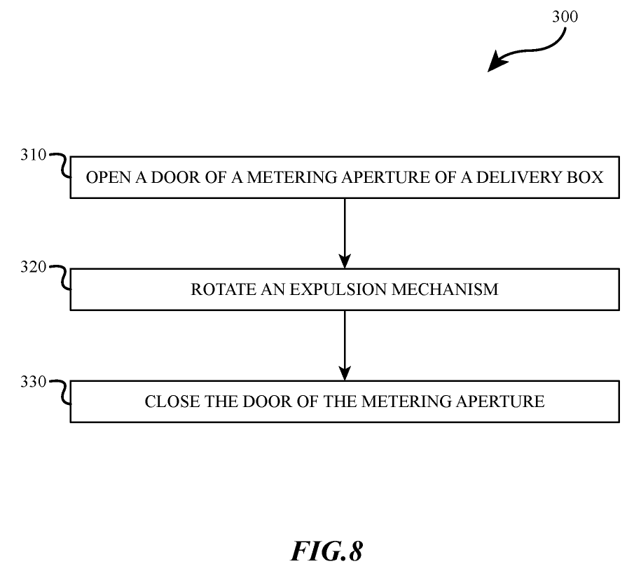

Also provided herein is a method of operating a delivery box system is presented. With reference to FIG. 8, a method of operating a delivery box system 300 includes the step 310 of opening a door of a metering aperture of a delivery box. As previously discussed, the door can be hinged or slidable. The door can be manually adjustable incrementally to provide a desired aperture size. The door may include markings or other indicators of the aperture size provided for a given door position to assist a user in selecting the door position. The indicators can include approximate volumetric and/or mass flow rates for fibrous and pelletized commodity materials. The door can also be actuated by a machine. For example, the door can include hydraulic actuators that move the door to a desired position in response to an input by a user.

At step 320, the expulsion mechanism is rotated, thereby causing a portion of the commodity material stored in the delivery box to be expulsed from the delivery box. The expulsion mechanism includes a distribution member that rotates around a vertical or near-vertical axis. In some embodiments, the axis is approximately perpendicular to a floor of the delivery box. The rotation of the distribution member causes the commodity material to flow out of the delivery box, driven by centrifugal force experienced by commodity material situation on the distribution member as it rotates. A portion of the distribution member extends through the metering aperture. Further, the distribution member can include agitation members that engage the commodity material stored in the delivery box. These agitation members will stir pelletized commodity material, preventing the formation of vacuoles in the commodity. In the case of fibrous or aggregated commodity material, the agitation members assist with breaking up the commodity material from the bulk body of commodity material, allowing the smaller pieces to be expulsed through the metering aperture. Material that has become positioned beneath the distribution member is able to move out through the metering aperture due to the space provided by the portion of the plate that extends through the metering aperture.

In another step 330, the door to the metering aperture is closed. Once the desired amount of commodity has been dispensed from the delivery box, the door to the delivery box is closed to prevent further distribution and potential waste of the commodity stored therein. The door can be closed manually or can be closed by the use of actuators in response to an input provided by an operator of the delivery box system. As discussed above, the bottom of the door should be curved or otherwise shaped so as to accommodate the distribution member that juts from the metering aperture such that a secure closure of the delivery box is provided when the door is in a closed position.

As utilized herein with respect to numerical ranges, the terms “approximately,” “about,” “substantially,” and similar terms generally mean +/- 10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that can result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining can be stationary (e.g., permanent or fixed) or moveable (e.g., removable or releasable). Such joining can be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling can be mechanical, electrical, or fluidic.

References herein to the positions of elements (e.g., “top,” “bottom,” “above,” “below”) are merely used to describe the orientation of various elements in the figures. It should be noted that the orientation of various elements can differ according to other embodiments, and that such variations are intended to be encompassed by the present disclosure.

Although the figures and description can illustrate a specific order of method steps, the order of such steps can differ from what is depicted and described, unless specified differently above. Also, two or more steps can be performed concurrently or with partial concurrence, unless specified differently above. Such variation can depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the various embodiments is illustrative only. Additionally, any element disclosed in one embodiment can be incorporated or utilized with any other embodiment disclosed herein.

What is claimed is:

1. A delivery box system comprising:
a delivery box having a bottom wall and a sidewall defining a storage area for storing a commodity material;
a first metering aperture disposed on the sidewall of the delivery box; and
an expulsion mechanism operable to dispense a stored commodity material through the first metering aperture,
wherein the expulsion mechanism includes a distribution member rotatable about an axis, the distribution member having an upper surface and a lower surface;
wherein a portion of the distribution member extends at least partially through the first metering aperture such that, in response to rotation of the distribution member, the stored commodity material is dispensed through the first metering aperture.

2. The delivery box system of claim 1, wherein the upper surface of the distribution member is angled with respect to the bottom wall of the delivery box.

3. The delivery box system of claim 2, wherein an angle of the upper surface of the distribution member is from about 15 to about 65 degrees with respect to a floor of the delivery box.

4. The delivery box system of claim 2, wherein the distribution member is a conical frustrum.

5. The delivery box system of claim 1, further comprising a central housing coupled to the distribution member adjacent an inner diameter of the distribution member, wherein the expulsion mechanism is mechanically coupled to a power source via the central housing.

6. The delivery box system of claim 1, further comprising a rib member extending across at least a portion of the lower surface of the distribution member.

7. The delivery box system of claim 1, further comprising a second expulsion mechanism including a second distribution member rotatable about an axis that is about vertical or that is about perpendicular to the bottom wall of the delivery box, the second distribution member having an upper surface and a lower surface,
wherein a portion of the second distribution member extends through a second metering aperture of the delivery box in operation of the delivery box system such that in response to rotation of the second distribution member, a commodity material stored in the delivery box is dispensed through the second metering aperture.

8. The delivery box system of claim 1, further comprising a door adjacent the first metering aperture, the door adjustable to incrementally move between a first open position and a second closed position thereby changing a size of an opening presented by the first metering aperture.

9. The delivery box system of claim 8, wherein a bottom portion of the door includes a curved recess configured to accommodate a portion of the distribution member when the door is in the second closed position.

10. The delivery box system of claim 1, further comprising an aperture plate disposed along at least a portion of a bottom edge of the first metering aperture, the aperture plate extending away from the delivery box at an angle relative to the bottom wall of the delivery box.

11. The delivery box system of claim 1 wherein the delivery box includes wheels or is mountable onto a wheeled trailer.

12. The delivery box system of claim 1, further comprising at least one agitation member disposed on the upper surface of the distribution member.

13. A delivery box system comprising:
a delivery box having a bottom wall and a sidewall defining a storage area for storing a commodity material,
a first metering aperture disposed on the sidewall of the delivery box;
a second metering aperture disposed on the sidewall of the delivery box;
a first angled plate positioned adjacent the first metering aperture and extending away from the delivery box at a first angle;
a second angled plate positioned adjacent a bottom portion of the second metering aperture and extending away from the delivery box at a second angle;
a first expulsion mechanism comprising a first distribution member a first central support joined to the first distribution member, the first expulsion mechanism positioned adjacent the first metering aperture and a portion of the first distribution member extending through the first metering aperture above the first angled plate; and
a second expulsion mechanism comprising a second distribution member and a second central support joined to the second distribution member, the second expulsion mechanism positioned adjacent the second metering aperture and a portion of the second distribution member extending through the second metering aperture above the second angled plate;
wherein the first expulsion mechanism and the second expulsion mechanism are each configured to rotate about a vertical axis or an axis that is perpendicular to the bottom wall of the delivery box, such that in response to rotation of the first distribution member and the second distribution member, the commodity material is dispensed through the first metering aperture and the second metering aperture.

14. The delivery box system of claim 13, wherein the first expulsion mechanism further comprises one or more agitator members extending from an upper surface of the first distribution member, the one or more agitator members configured to engage a commodity stored in the delivery box.

15. The delivery box system of claim 14, wherein the one or more agitator members are adjustable in height.

16. The delivery box system of claim 13, wherein the first expulsion mechanism further comprises a rib member extending along a portion of a lower surface of the first distribution member.

17. The delivery box system of claim 16, wherein the rib member is configured to, via rotation of the first distribution member, engage a portion of a commodity stored in the delivery box below the first distribution member and move the portion of a commodity towards the first metering aperture.

18. The delivery box system of claim 13, further comprising a power source, the power source mechanically coupled to the first central support such that the first distribution member rotates around a vertical axis in operation.

19. The delivery box system of claim 13, wherein the first expulsion mechanism is configured to rotate around a vertical axis in a first direction and the second expulsion mechanism is configured to rotate around a vertical axis in a second direction.

20. A method of operating a delivery box system, the method comprising:
opening a door of a metering aperture of a delivery box to a desired position;
rotating an expulsion mechanism thereby ejecting at least a portion of a commodity stored within the delivery box through the metering aperture; and
closing the door associated with the metering aperture,
wherein the expulsion mechanism includes a distribution member configured to rotate around an axis perpendicular to a floor of the delivery box to dispense the commodity,
wherein a portion of the distribution member extends through the metering aperture during operation of the delivery box system.
